(19) United States
(12) Patent Application Publication
(10) Pub. No.: US 2026/0175145 A1
(43) Pub. Date: Jun. 25, 2026

(54) FILTRATE COLLECTION UNIT FOR FILTER PLATE IN FILTER PRESSES

(71) Applicant: THEJO ENGINEERING LIMITED, Chennai (IN)

(72) Inventors: Manoj JOSPEH K, Chennai (IN); Jomon MATHEW, Chennai (IN); Pravin M, Chennai (IN)

(21) Appl. No.: 19/124,892

(22) PCT Filed: Jan. 11, 2023
(86) PCT No.: PCT/IN2023/050025

§ 371 Date: Apr. 28, 2025

(30) Foreign Application Priority Data
Nov. 22, 2022 (IN) 202241066941

(51) Int. Cl. B01D 25/164; B01D 25/21; B01D 29/58; B01D 35/30; B01D 61/18; B01D 63/08

(52) U.S. Cl. CPC B01D 25/164; B01D 25/215; B01D 29/58; B01D 35/30; B01D 61/18; B01D 63/084

(57) ABSTRACT

Disclosed is a filtrate collection unit (104) having a wear nozzle (108). The wear nozzle (108) includes a tubular portion (202) that is provided with a first aperture (208) and a second aperture (210). The first aperture (208) is adapted to receive fluid from a filter plate (100). The first aperture (208) has an elliptical profile. The second aperture (210) is disposed opposite to the first aperture (208) along a longitudinal axis (A-A′) of the tubular portion (202) such that the second aperture (210) ejects filtrate of the fluid received via the first aperture (208) out of the tubular portion (202).

### TECHNICAL FIELD

The present disclosure relates generally to a field of filter presses. More particularly, the present disclosure relates to a filtrate collection unit for a filter plate in a filter press.

### BACKGROUND

Filter presses are well known for solid-liquid separation in mineral ore processing and chemical industries. There are generally two types of filter presses i.e., horizontal type filter press and vertical type filter press based on the stacking arrangement/orientation of the filter plates. In the horizontal type of filter press, the filter plates are horizontally stacked for enabling filtration of slurry in the ore processing and chemical industries. The slurry is fed in the filter press that gets trapped between the filter plates. The filter plates are then pressed by rubber diaphragms that are fitted onto the filter plates such that the filter plates pressurize the slurry that is trapped between the filter plates. A filter cloth is generally deployed between the filter plates to enable filtration of the slurry.

The slurry is filled up to the corners of the filter plates from where the finer solid particles (abrasives) are drained out from the corners of filter press along with water or the process fluid. This causes solid-liquid separation in the slurry that is produced in the ore processing and chemical industries. The corners of the filter plates get abraded when the slurry from the corners gets drained. This damage the corners of the filter plates that requires replacement of the whole filter plate in the filter press.

In order to prevent damage of the whole filter plate, a removable insert is provided at the corners of the filter plate. The removable insert includes a number of pipes or tubes that are inserted from outside the filter plates. The pipes allow passage of abrasive fluid from the corners of the filter plate to enable drainage of the abrasive particles from the filter press. But in the conventional removable inserts, the abrasive/slurry or other particles gets stuck between the pipes which causes abrasion of the walls or surfaces of the corner that lies between the pipes.

Furthermore, the pipes of the removable insert cause improper passage of the slurry which decreases the flow rate of the slurry. This increases the filtration time and thereby increasing the residual moisture content in filter cake.

Therefore, there exists a need for an efficient filtrate collection unit that is capable of solving the aforementioned problems.

### SUMMARY

In view of the foregoing, a filtrate collection unit is disclosed. The filtrate collection unit includes a wear nozzle having a tubular portion. The tubular portion of the wear nozzle though a single tube includes a first aperture and a second aperture. The first aperture is adapted to receive fluid from the filter plate. The first aperture has an elliptical profile. The second aperture is disposed opposite to the first aperture along a longitudinal axis of the tubular portion such that the second aperture ejects filtrate of the fluid received via the first aperture out of the tubular portion.

The wear nozzle further includes a plate that is disposed on the tubular portion between the first aperture and the second aperture such that the plate extends along a lateral axis of the tubular portion to couple the wear nozzle on a corner of the filter plate.

In some aspects, the first aperture is removably inserted to a slot that is disposed on a corner of the filter plate.

In some aspects, the filtrate collection unit further includes a collector block that is removably coupled to the plate via a first set of fasteners and configured to drain out the filtrate of the fluid out from the filter plate.

In some aspects, the collector block further includes a slit that is configured to receive the second aperture such that the second aperture conveys the fluid from the filter plate to the collector block. The collector block further includes a drain port that is orthogonally disposed with respect to the slit and configured to drain out the filtrate of the fluid from the filter plate.

In some aspects, the wear nozzle further includes a seal pad that is disposed on either side of the plate such that the seal pad prevents leaking out of the fluid from the wear nozzle.

In some aspects, curvature formed by the elliptical profile of the first aperture has radius that lies in a range between 220 milli-meter and 250 milli-meter.

In some aspects, width of the tubular portion lies in a range between 75 milli-meter and 90 milli-meter.

In some aspects, length of the tubular portion lies in a range between 265 milli-meter and 310 milli-meter.

In some aspects, the tubular portion and the plate forms a monolith structure.

In some aspects, a filter plate is disclosed. The filter plate includes plurality of corners such that each corner of the plurality of corners includes a filtrate collection unit filtrate collection unit that is removably disposed on each corner of the plurality of corners. The filtrate collection unit includes a wear nozzle having a tubular portion. The tubular portion of the wear nozzle includes a first aperture and a second aperture. The first aperture is adapted to receive fluid from a filter plate. The first aperture has an elliptical profile. The second aperture is disposed opposite to the first aperture along a longitudinal axis of the tubular portion such that the second aperture ejects filtrate of the fluid received via the first aperture out of the tubular portion.

In some aspects, the wear nozzle further includes a plate that is disposed on the tubular portion between the first aperture and the second aperture such that the plate extends along a lateral axis of the tubular portion to couple the wear nozzle on each corner of the plurality of corners of the filter plate.

In some aspects, the filter plate further includes a slot that is disposed on each corner of the plurality of corners such that the first aperture is removably received within the slot.

In some aspects, the filtrate collection unit further includes a collector block that is removably coupled to the plate via a first set of fasteners and configured to drain out the filtrate of the fluid from the filter plate.

In some aspects, the collector block further includes a slit that is configured to receive the second aperture such that the second aperture conveys the fluid from the filter plate to the collector block and a drain port that is configured to drain out the filtrate of the fluid from the filter plate.

### BRIEF DESCRIPTION OF DRAWINGS

The above and still further features and advantages of aspects of the present disclosure becomes apparent upon consideration of the following detailed description of aspects thereof, especially when taken in conjunction with the accompanying drawings, and wherein:

FIG. 1 illustrates a perspective view of a filter plate, in accordance with an embodiment herein;

FIG. 2A and FIG. 2B illustrate a perspective view of a wear nozzle of a filtrate collection unit, in accordance with an embodiment herein;

FIG. 3A illustrates a perspective exploded view of a first corner of the filter plate of FIG. 1, in accordance with an embodiment herein; and

FIG. 3B illustrates a perspective collapsed view of the first corner of the filter plate of FIG. 1, in accordance with an embodiment herein.

To facilitate understanding, like reference numerals have been used, where possible, to designate like elements common to the figures.

### DETAILED DESCRIPTION

Various aspects of the present disclosure provide a filtrate collection unit of a filter plate. The following description provides specific details of certain aspects of the disclosure illustrated in the drawings to provide a thorough understanding of those aspects. It should be recognized, however, that the present disclosure can be reflected in additional aspects and the disclosure may be practiced without some of the details in the following description.

The various aspects including the example aspects are now described more fully with reference to the accompanying drawings, in which the various aspects of the disclosure are shown. The disclosure may, however, be embodied in different forms and should not be construed as limited to the aspects set forth herein. Rather, these aspects are provided so that this disclosure is thorough and complete, and fully conveys the scope of the disclosure to those skilled in the art. In the drawings, the sizes of components may be exaggerated for clarity.

It is understood that when an element or layer is referred to as being “on,” “connected to,” or “coupled to” another element or layer, it can be directly on, connected to, or coupled to the other element or layer or intervening elements or layers that may be present. As used herein, the term “and/or” includes any and all combinations of one or more of the associated listed items.

The subject matter of example aspects, as disclosed herein, is described with specificity to meet statutory requirements. However, the description itself is not intended to limit the scope of this disclosure. Rather, the inventor/inventors have contemplated that the claimed subject matter might also be embodied in other ways, to include different features or combinations of features similar to the ones described in this document, in conjunction with other technologies. Generally, the various aspects including the example aspects relate to a filtrate collection unit of a filter plate.

As mentioned, there remains a need for efficient filtrate collection unit that is capable of increasing rate of flow of the fluid from the corners of the filter plate hence reducing the filtration time. Furthermore, there remains a need to provide a filtrate collection unit that is capable of reducing the residual moisture content in a filter cake that causes proper solid-liquid separation in a filter press.

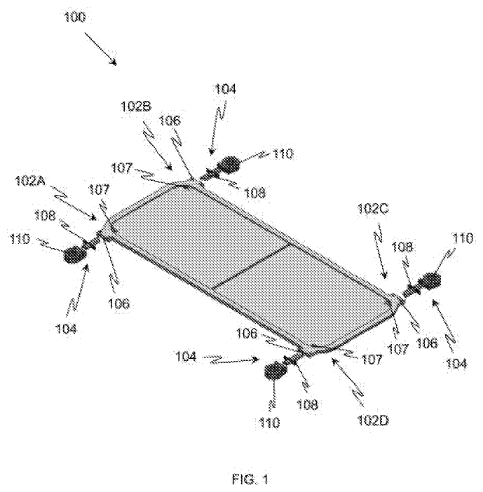

FIG. 1 illustrates a perspective view of a filter plate 100, in accordance with an embodiment herein. The filter plate 100 may be deployed in a filter press (not shown). The filter press may be a horizontal type press or a vertical type press. The filter press may be deployed in a mineral processing and chemical industries for solid-liquid separation. The solid-liquid separation may be executed by applying pressure on a fluid i.e., generally a slurry mixture, via a diaphragm of the filter plate 100. The filter press may include a plurality of filter plates for applying pressure on the fluid to enable solid-liquid separation that separates larger solid particles of the fluid from the liquid and finer particles such that the liquid and finer particles are drained from corners of the filter plate 100. The fluid upon filling in the chambers of the filter plate 100, gets pressurized within the number of plates and reaches up to the corners of the filter plate 100. The larger solid particles of the fluid may be retained by a filter cloth (not shown) that is disposed between the number of filter plates of the filter press. The larger solid particles of the fluid that are retained by the filter cloth may be formed as a cake with less moisture. Preferably, the moisture content for the cake may be maintained below 15%. The filter cloth thus acts as a semi-permeable membrane to restrict the larger solid particles from draining.

In some embodiments, the filter press may be employed in metal ore processing industry.

The filter plate 100 may include a plurality of corners 102 of which first through fourth corners 102A-102D are shown in FIG. 1. Each corner 102A of the plurality of corners 102 may include a filtrate collection unit 104, a slot 106, and a recess 107. The filtrate collection unit 104 may be removably disposed on each corner 102A of the plurality of corners 102. The filtrate collection unit 104 may include a wear nozzle 108 and a collector block 110. The recess 107 may be adapted to guide the fluid toward the slot 106 and the slot 106 may further be adapted to guide the fluid towards the wear nozzle 108. The wear nozzle 108 may act as a removable insert (sacrificial device) that gets worn out upon prolonged passage of the fluid from the slot 106 of each corner 102A of the plurality of corners 102. This way, the wear nozzle 108 prevents wear of the first through four corners 102A-102D of the filter plate 100 and also the entire filter plate 100. The wear nozzle 108 thus prevents replacement of the entire filter plate 100 and only the wear nozzle 108 needs to be replaced upon prolonged passage of the fluid.

In some embodiments, the recess 107 may be notch that is disposed near to the slot 106 of each corner 102A of the first through fourth corners 102A-102D.

In operation, the fluid may be injected in the filter press such that the slurry gets pressurized between the number of filter plates of the filter press. The fluid, upon being pressurized within the number of filter plates, reaches up to each corner 102A of the first through four corners 102A-102D of the filter plate 100. The larger solid particles of the fluid may be retained by a filter cloth (not shown) that is disposed between the number of filter plates of the filter press. The larger solid particles of the fluid, upon being retained by the filter cloth, forms a cake with less moisture. The filter cloth may thus act as a semi-permeable membrane to restrict the larger solid particles of the fluid from draining. The slot 106 of each corner 102A of the first through four corners 102A-102D may be adapted to guide the fluid towards the wear nozzle 108.

Although FIG. 1 illustrates that the filter plate 100 includes four corners (i.e., first through four corners 102A-102D), it will be apparent to a person skilled in the art that the scope of the present disclosure is not limited to it. In various other aspects, the filter plate 100 may include more than four corners without deviating from the scope of the present disclosure. In such a scenario, each corner is configured to perform one or more operations in a manner similar to the operations of the first through four corners 102A-102D as described herein.

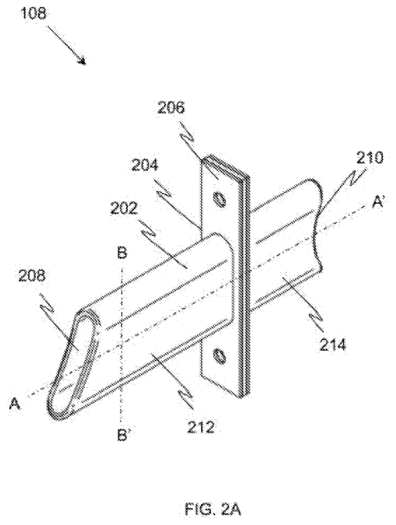

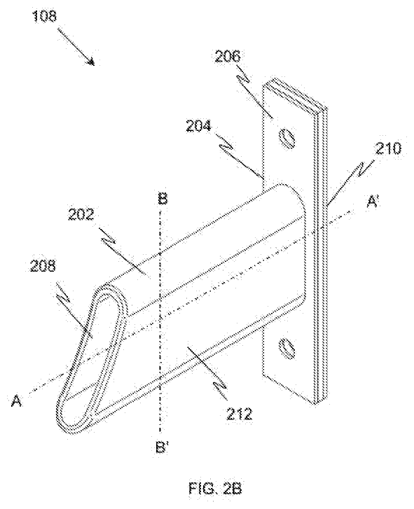

FIG. 2A and FIG. 2B illustrate a perspective view of the wear nozzle 108 of the filtrate collection unit 104, in accordance with an embodiment herein. The wear nozzle 108 may include a tubular portion 202, a plate 204, and a seal pad 206. The tubular portion 202 may include a first aperture 208 and a second aperture 210. The tubular portion 202 may include a first portion 212 and a second portion 214.

In some embodiments, the first aperture 208 may have profile such as, but not limited to, an ellipse (elliptical), a square, a rectangle, an oval, a circle, and the like. Embodiments of the present disclosure are intended to include and/or otherwise cover any type of the profile for the first aperture 208, without deviating from the scope of the present disclosure.

The second aperture 210 may be disposed opposite to the first aperture 208 along a longitudinal axis A-A′ (as shown in direction index) of the tubular portion 202. The plate 204 may be disposed on the tubular portion 202 between the first aperture 208 and the second aperture 210 such that the plate 204 extends along a lateral axis B-B′ (as shown in direction index) of the tubular portion 202 to couple the wear nozzle 108 on each corner 102A of the first through four corners 102A-102D of the filter plate 100. The first portion 212 of the tubular portion 202 may extend from the first aperture 208 up to the plate 204. The second portion 214 of the tubular portion 202 may extend from the plate 204 up to the second aperture 210. The seal pad 206 may be disposed on either side of the plate 204 such that the seal pad 206 prevents leaking out of the fluid from the wear nozzle 108.

In some embodiments, curvature formed by the elliptical profile of the first aperture 208 may have radius that lie in a range between 220 milli-meters and 250 milli-meters. Preferably, the curvature of the elliptical profile may have radius of 227 milli-meters. Embodiments of the present disclosure are intended to include and/or otherwise cover any value of the radius of the curvature formed by the elliptical profile of the first aperture 208.

In some embodiments, width of the tubular portion 202 of the wear nozzle 108 may lie in a range between 75 milli-meter and 90 milli-meter. Preferably, the width of the tubular portion 202 may be 79 milli-meters. Embodiments of the present disclosure are intended to include and/or otherwise cover any value of the width of the tubular portion 202.

In some embodiments, height of the tubular portion 202 of the wear nozzle 108 may lie in a range between 15 milli-meter and 30 milli-meter. Preferably the height of the tubular portion 202 of the wear nozzle 108 may be 19 milli-meters. Embodiments of the present disclosure are intended to include and/or otherwise cover any value of the height of the tubular portion 202.

In some embodiments, length of the tubular portion 202 of the wear nozzle 108 may lie in a range between 265 milli-meter and 310 milli-meter. Preferably, the length of the tubular portion 202 of the wear nozzle 108 may be 267 milli-meters. Embodiments of the present disclosure are intended to include and/or otherwise cover any value of the length of the tubular portion 202.

In some embodiments, the tubular portion 202 and the plate 204 may form a monolith structure.

In some embodiments, the plate 204 may be welded between the first aperture 208 and the second aperture 210 on the tubular portion 202.

In some embodiments, the wear nozzle 108 may be manufactured from steel. The wear nozzle 108 may be manufactured from one of high strength material, engineered plastic, and high abrasion resistant material. Embodiments of the present disclosure are intended to include and/or otherwise cover any type of material for the wear nozzle 108, including known, related and later developed materials.

In some embodiments, the wear nozzle 108 may be coated or reinforced with materials that are selected from ceramic, rubber, and polyurethane (PU). While coating or reinforcing the wear nozzle 108, the material may be coated at an inner side and at an outer side of the wear nozzle 108. The wear nozzle 108 is reinforced to increase the life of the wear nozzle 108. Preferably, the outer side of the wear nozzle 108 may be coated with materials like rubber and/or polyurethane to avoid any leakage of the fluid from the wear nozzle 108.

In some embodiments, width of the plate 204 of the wear nozzle 108 may lie in a range between 200 milli-meters and 250 milli-meters. Preferably, the width of the plate 204 of the wear nozzle 108 may be 220 milli-meters.

In some embodiments, height of the plate 204 of the wear nozzle 108 may lie in a range between 40 milli-meters and 50 milli-meters. Preferably, the height of the plate 204 of the wear nozzle 108 may be 45 milli-meters. Embodiments of the present disclosure are intended to include and/or otherwise cover any value of the height of the plate 204.

In some embodiments, thickness of the plate 204 of the wear nozzle 108 may lie in a range between 3 milli-meters and 7 milli-meters. Preferably, the thickness of the plate 204 of the wear nozzle 108 may be 5 milli-meters. Embodiments of the present disclosure are intended to include and/or otherwise cover any value of the thickness of the plate 204.

In some embodiments, the plate 204 may be disposed about 104 milli-meters apart from the second aperture 210 on the tubular portion 202 of the wear nozzle 108.

In some embodiments, the second aperture 210 may exhibit a curved profile such that the radius of the curved profile of the second aperture 210 may lie in a range between 60 milli-meters and 70 milli-meters. Preferably, the radius of the curved profile of the second aperture 210 may be 65 milli-meters. Embodiments of the present disclosure are intended to include and/or otherwise cover any value of the radius of the curved profile of the second aperture 210.

In some embodiments, the seal pad 206 may be manufactured from material comprising one of a rubber, and a polyurethane. Aspects of the present disclosure are intended to include and/or otherwise cover any type of material for the seal pad 206 that is capable for sealing, including known, related and later developed materials.

The plate 204 may include a first set of holes (not shown). The collector block 110 may include a second set of holes (not shown). To assemble the filtrate collection unit 104, the first set of holes of the plate 204 may be aligned with the second set of holes of the collector block 110. Upon alignment of the first set of holes with the second set of holes, a first set of fasteners may be passed through the first set of holes and the second set of holes to assemble the filtrate collection unit 104. This way the collector block 110 may be removably coupled to the plate 204.

In some embodiments, the first set of fasteners may include rivets, screws, studs, bolts and the like.

Each corner 102A of the first through four corners 102A-102D may further include a third set of holes (not shown). To removably dispose the filtrate collection unit 104 on each corner 102A of the first through four corners 102A-102D, the first aperture 208 may be removably inserted to the slot 106 such that the first set of holes of the plate 204 aligns with the third set of holes of each corner 102A of the first through four corners 102A-102D. The first aperture 208 may be designed such that the first aperture 208 suits with shape of the slot 106 of each corner 102A of the first through four corners 102A-102D that facilitates easy insertion of the first aperture 208 within the slot 106. Upon insertion of the first aperture 208 within the slot 106, the tubular portion 202 rests on the recess 107 of each corner 102A of the first through fourth corners 102A-102D such that the tubular portion 202 flushes with the recess 107. Upon alignment of the first set of holes with the third set of holes, a second set of fasteners may be passed through the first set of holes and the third set of holes to removably dispose the filtrate collection unit 104 on each corner 102A of the first through four corners 102A-102D.

In some embodiments, the second set of fasteners may include rivets, screws, studs, and the like.

Specifically, FIG. 2B illustrates an exemplary embodiment of the wear nozzle 108 having the tubular portion 202 without the second portion 214. The second aperture 210 may therefore lie on the plate 204.

In operation, the first aperture 208 of the tubular portion 202 of the wear nozzle 108 may be adapted to receive the fluid from the filter plate 100 that reaches up to each corner 102A of the first through four corners 102A-102D. In some preferred embodiments, the elliptical profile of the first aperture 208 may be adapted to facilitate smooth entrance of the fluid from the filter plate 100 into the tubular portion 202 of the wear nozzle 108. The tubular portion 202 may be adapted to provide passage to the fluid from the first aperture 208 to the second aperture 210. The second aperture 210 may be adapted to eject filtrate of the fluid received via the first aperture 208 out of the tubular portion 202.

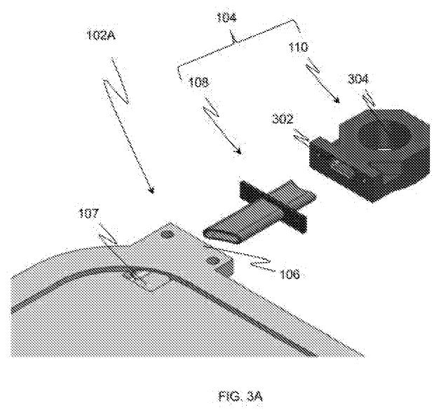

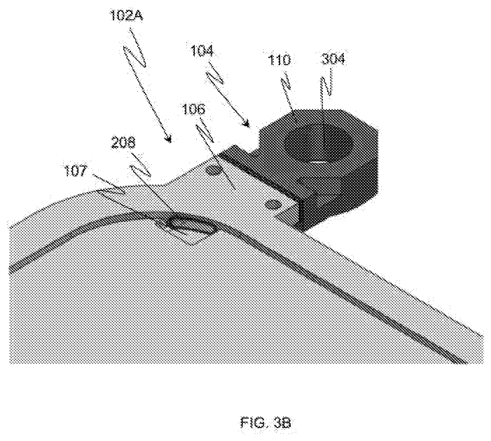

FIG. 3A illustrates a perspective exploded view of the first corner 102A of the filter plate 100 of FIG. 1, in accordance with an embodiment herein. The collector block 110 may include a slit 302 and a drain port 304. The slit 302 may be orthogonally disposed with respect to the drain port 304. The slit 302 may be fluidically arranged with the drain port 304 such that the fluid passes from the slit 302 to the drain port 304. While assembling the filtrate collection unit 104, the slit 302 of the collector block 110 may be adapted to receive the second aperture 210 of the wear nozzle 108, by way of inserting the second portion 214 of the tubular portion 202 in the slit 302. This aligns the first set of holes of the plate 204 with the second set of holes of the collector block 110 that facilitates removable coupling of the collector block 110 with the plate 204 of the wear nozzle 108. The second aperture 210 may be designed such that the second aperture 210 may be adapted to blend in with the slit 302 of the collector block 110.

In some embodiments, the slit 302 may have shape such as, but not limited to, a square, a rectangle, an oval, a circle, and the like. Embodiments of the present disclosure are intended to include and/or otherwise cover any type of the shape for the slit 302, without deviating from the scope of the present disclosure.

In some embodiments, the drain port 304 may have shape such as, but not limited to, a circle, a square, a rectangle, an oval, and the like. Embodiments of the present disclosure are intended to include and/or otherwise cover any type of the shape for the drain port 304, without deviating from the scope of the present disclosure.

FIG. 3B illustrates a perspective collapsed view of the first corner 102A of the filter plate 100 of FIG. 1, in accordance with an embodiment herein. Specifically, FIG. 3B shows the wear nozzle 108 and the collector block 110 being removably coupled to the first corner 102A of the first through four corners 102A-102D of the filter plate 100.

In operation, the filtrate of the fluid, upon being ejected out via the second aperture 210 of the tubular portion 202, may enter into the collector block 110 via the slit 302. The fluid may eventually get drained out from the filter plate 100 via the drain port 304 of the collector block 110. The fluid that gets drained from the drain port 304 may carry away the filtrate i.e., finer abrasive particles that gets separated from the fluid. Once the wear nozzle 108 gets damaged, the wear nozzle 108 may be easily replaceable with another wear nozzle 108.

In some embodiments, to assemble the filtrate collection unit 104, the collector block 110 may be mounted on to the plate 204 of the wear nozzle 108, which avoids insertion of the second portion 214 of the tubular portion 202 into the slit 302 of the collector block 110. The first set of holes of the plate 204 may be aligned with the second set of holes of the collector block 110 in order to removably mount the collector block 110 on the plate 204 of the wear nozzle 108.

Although FIGS. 3A and 3B illustrates structure and working of the first corner 102A of the first through four corners 102A-102D, it will be apparent to a person skilled in the art that the scope of the present disclosure is not limited to it. In various other aspects, the structure and working of each corner of the plurality of corners 102 of the filter plate 100 is similar to the first corner 102A of the first through four corners 102A-102D without deviating from the scope of the present disclosure. In such a scenario, each corner is configured to perform one or more operations in a manner similar to the operations of the first corner 102A of the first through four corners 102A-102D as described herein.

Thus, the filter plate 100 and the wear nozzle 108 provide following advantages that are derived from the structural and functional aspects of the filter plate 100 and the wear nozzle 108:—
The elliptical profile of the first aperture 208 of the wear nozzle 108 allow smooth entrance of the fluid from the slot 106 of the filter plate 100.
The elliptical profile of the first aperture 208 improves the rate of flow of the fluid from the wear nozzle 108 which reduces the filtration time while filtering the fluid.
The elliptical profile of the first aperture 208 increases quantity of filtrate entraining into the first aperture 208 which allows more abrasive/filtrate to eject from the filtrate collection unit 104. This reduces the moisture content of the cake (slurry that gets trapped between the number of filter plates).
The elliptical profile by reducing filtration time is capable of increasing efficiency of the filtrate collection unit 104.
The filtrate collection unit 104 does not affect the rigidity of the filter plate 100 when the filtrate collection unit 104 is disposed on each corner 102A of the plurality of corners 102 of the filter plate 100.
The filtrate collection unit 104 prevents replacement of the whole filter plate 100 which reduces the cost of filtration in the filter press.
The filtrate collection unit 104 decreases the frequency of replacement of the filter plate 100 in the filter press.
The filtrate collection unit 104 is easily installed at the plurality of corners 102 of the filter plate 100.

The foregoing discussion of the present disclosure has been presented for purposes of illustration and description. It is not intended to limit the present disclosure to the form or forms disclosed herein. In the foregoing Detailed Description, for example, various features of the present disclosure are grouped together in one or more aspects, configurations, or aspects for the purpose of streamlining the disclosure. The features of the aspects, configurations, or aspects may be combined in alternate aspects, configurations, or aspects other than those discussed above. This method of disclosure is not to be interpreted as reflecting an intention the present disclosure requires more features than are expressly recited in each claim. Rather, as the following claims reflect, inventive aspects lie in less than all features of a single foregoing disclosed aspect, configuration, or aspect. Thus, the following claims are hereby incorporated into this Detailed Description, with each claim standing on its own as a separate aspect of the present disclosure.

Moreover, though the description of the present disclosure has included description of one or more aspects, configurations, or aspects and certain variations and modifications, other variations, combinations, and modifications are within the scope of the present disclosure, e.g., as may be within the skill and knowledge of those in the art, after understanding the present disclosure. It is intended to obtain rights which include alternative aspects, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

We claim:

1. A filtrate collection unit (104) comprising:
a wear nozzle (108) comprising:
a tubular portion (202) comprising:
a first aperture (208) adapted to receive fluid from a filter plate (100); and
a second aperture (210) disposed opposite to the first aperture (208) along a longitudinal axis (A-A′) of the tubular portion (202) such that the second aperture (210) ejects filtrate of the fluid received via the first aperture (208) out of the tubular portion (202).

2. The filtrate collection unit (104) as claimed in claim 1, wherein the first aperture (208) has an elliptical profile.

3. The filtrate collection unit (104) as claimed in claim 1, wherein the wear nozzle (108) further comprising a plate (204) that is disposed on the tubular portion (202) between the first aperture (208) and the second aperture (210) such that the plate (204) extends along a lateral axis (B-B′) of the tubular portion (202) to couple the wear nozzle (108) on a corner (102A) of the filter plate (100).

4. The filtrate collection unit (104) as claimed in claim 1, wherein to removably dispose the filtrate collection unit (104) on a corner (102A) of the filter plate (100), the first aperture (208) is removably inserted to a slot (106) that is disposed on a corner (102A) of the filter plate (100).

5. The filtrate collection unit (104) as claimed in claims 1 and 2, further comprising a collector block (110) that is removably coupled to the plate (204) via a first set of fasteners and configured to drain out the filtrate from the filter plate (100).

6. The filtrate collection unit (104) as claimed in claims 1 and 4, wherein the collector block (110) further comprising:
a slit (302) that is configured to receive the second aperture (210) such that the second aperture (210) conveys the fluid from the filter plate (100) to the collector block (110); and
a drain port (304) that is orthogonally disposed with respect to the slit (302) and configured to drain out the filtrate from the filter plate (100).

7. The filtrate collection unit (104) as claimed in claims 1 and 2, wherein the wear nozzle (108) further comprising a seal pad (206) that is disposed on either side of the plate (204) such that the seal pad (206) prevents leaking out of the fluid from the wear nozzle (108).

8. The filtrate collection unit (104) as claimed in claim 1, wherein curvature formed by the elliptical profile of the first aperture (208) has radius that lies in a range between 220 milli-meter and 250 milli-meter.

9. The filtrate collection unit (104) as claimed in claim 1, wherein width of the tubular portion (202) lies in a range between 75 milli-meter and 90 milli-meter.

10. The filtrate collection unit (104) as claimed in claim 1, wherein length of the tubular portion (202) lies in a range between 265 milli-meter and 310 milli-meter.

11. The filtrate collection unit (104) as claimed in claims 1 and 2, wherein the tubular portion (202) and the plate (204) forms a monolith structure.

12. A filter plate (100) comprising:
plurality of corners (102) such that each corner (102A) of the plurality of corners (102) comprising:
a filtrate collection unit (104) that is removably disposed on each corner (102A) of the plurality of corners (102), the filtrate collection unit (104) comprising:
a wear nozzle (108) comprising:
a tubular portion (202) comprising:
a first aperture (208) adapted to receive fluid from a filter plate (100); and
a second aperture (210) disposed opposite to the first aperture (208) along a longitudinal axis (A-A′) of the tubular portion (202) such that the second aperture (210) ejects filtrate of the fluid received via the first aperture (208) out of the tubular portion (202).

13. The filtrate plate (100) as claimed in claim 12, wherein the first aperture (208) has an elliptical profile.

14. The filter plate (100) as claimed in claim 12, wherein the wear nozzle (108) further comprising a plate (204) that is disposed on the tubular portion (202) between the first aperture (208) and the second aperture (210) such that the plate (204) extends along a lateral axis (B-B′) of the tubular portion (202) to couple the wear nozzle (108) on each corner (102A) of the plurality of corners (102) of the filter plate (100).

15. The filter plate (100) as claimed in claim 12, wherein each corner (102A) of the plurality of corners (102) further comprising a slot (106) that is configured to receive the first aperture (208) of the wear nozzle (108).

16. The filter plate (100) as claimed in claims 12 and 14, wherein the filtrate collection unit (104) further comprising a collector block (110) that is removably coupled to the plate (204) via a first set of fasteners and configured to drain out the filtrate of the fluid from the filter plate (100).

17. The filter plate (100) as claimed in claim 16, wherein the collector block (110) further comprising:
a slit (302) that is configured to receive the second aperture (210) such that the second aperture (210) conveys the fluid from the filter plate (100) to the collector block (110); and
a drain port (304) that is configured to drain out the filtrate of the fluid from the filter plate (100).
